(19) United States
(12) Patent Application Publication
(10) Pub. No.: US 2015/0169568 A1
(43) Pub. Date: Jun. 18, 2015

(54) METHOD AND APPARATUS FOR ENABLING DIGITAL MEMORY WALLS

(71) Applicant: Laura Garcia-Barrio, Brooklyn, NY (US)

(72) Inventor: Laura Garcia-Barrio, Brooklyn, NY (US)

(21) Appl. No.: 13/422,836

(22) Filed: Mar. 16, 2012

(51) Int. Cl. G06F 17/30; G06K 9/46; G06K 9/62

(52) U.S. Cl. CPC G06F 17/3028; G06K 9/46

(57) ABSTRACT

A method and apparatus for enabling memory walls is described. The method may include receiving digital image data and location data captured by a mobile device. The method may also include performing image recognition analysis on objects within the digital image data to recognize a physical marking on a surface of an object in the digital image data. The method may also include determining that a recognized physical marking is associated with a digital memory wall based on the recognized physical marking and the location data. The method may also include providing digital media associated with the digital memory wall to the mobile device to be rendered over the surface of the object, where the digital memory wall acts as a digital bulletin board.

### TECHNICAL FIELD

Embodiments of the invention relate to the field of augmenting reality, and more particularly, to enabling digital memory walls.

### BACKGROUND

Many venues like featuring pictures of their customers, and welcome people writing messages on walls, napkins, etc. One problem associated with this type of patron communication is that there is only a limited amount of space for the messages and notes. Furthermore, old messages and photos may not be relevant to recent patron experiences at the venue.

Online rating and review service providers enable users to share photos and comments about a venue. A user must first navigate to the service provider's website, or open the service providers corresponding native application. The user must then select the venue from among many possible venues. Finally, a user is able to view or post comments to the service provider's web site. Other users may then navigate to the service provider web site to view the photos, user reviews, etc. The photos and comments at such online service provider web sites, however, are disconnected from the venues that are the subject of the photographs and reviews.

### SUMMARY

A method and apparatus for enabling memory walls is described. According to an exemplary method, digital image data and location data captured by a mobile device are received. In one embodiment, image recognition analysis is performed on objects within the digital image data to recognize a physical marking on a surface of an object in the digital image data. In one embodiment, a recognized physical marking is determined to be associated with a digital memory wall based on the recognized physical marking and the location data. In one embodiment, digital media associated with the digital memory wall is provided to the mobile device to be rendered over the surface of the object, where the digital memory wall acts as a digital bulletin board.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of exemplary system architecture for enabling digital memory walls.

FIG. 2 is a block diagram of one embodiment of a memory wall system and a memory wall client.

FIG. 3 is a flow diagram of one embodiment of a method for enabling digital memory wall proximity notifications.

FIG. 4 is a flow diagram of one embodiment of a method for supplying digital memories for a digital memory wall.

FIG. 5 is a flow diagram of one embodiment of a method for enabling the addition of content to an existing digital memory wall.

FIG. 6 illustrates a diagrammatic representation of a machine in the exemplary form of a computer system.

FIG. 7 illustrates an example system for receiving, transmitting, and displaying digital memories.

FIG. 8 illustrates an alternate view of an example system for receiving, transmitting, and displaying virtual tags.

FIG. 9 illustrates an example schematic drawing of a computer network infrastructure.

### DETAILED DESCRIPTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “performing”, “determining”, “providing”, “querying”, “adding”, “locating”, “filtering”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

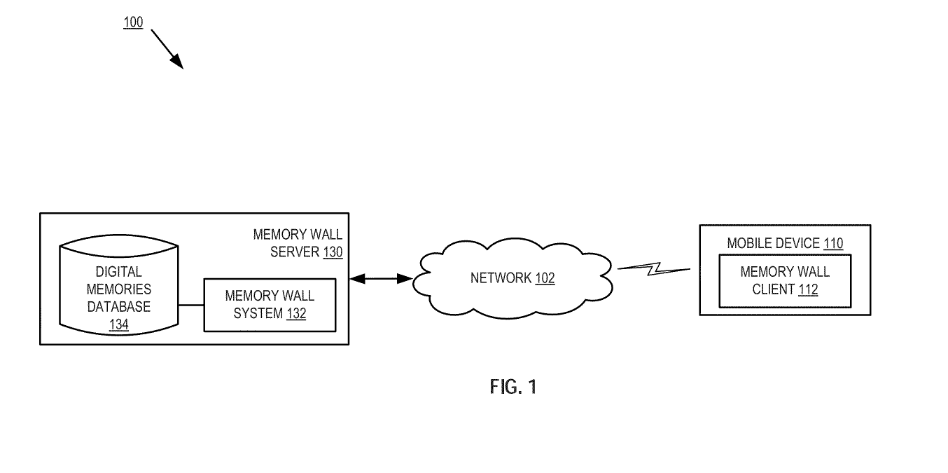

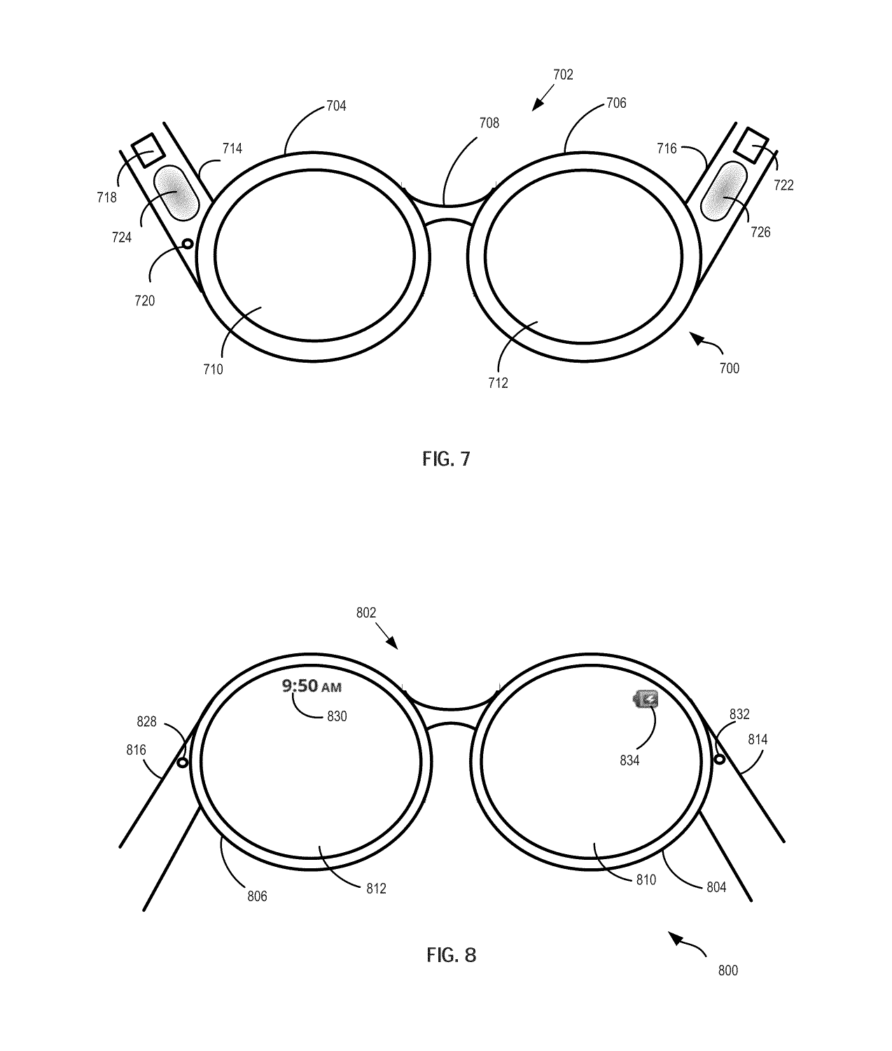

FIG. 1 is a block diagram of exemplary system architecture 100 for enabling digital memory walls. In one embodiment, the system 100 includes mobile device 110 and memory wall server 130. In one embodiment, mobile device 110 may be a binocular wearable computing device as illustrated in FIGS. 7 and 8, a monocular wearable computing device (i.e., a single eye head mounted display similar to those described in FIGS. 7 and 8), as well as a cellular telephone, tablet computer, etc. The memory wall server 130 may also be a computing device, such as a server computer, desktop computer, etc.

The mobile device 110 and memory wall server 130 may be coupled to a network 102 that communicates any of the standard protocols for the exchange of information. In one embodiment, mobile device 110 is coupled with network 102 via a wireless connection, such as a cellular telephone connection, wireless fidelity connection, etc. The mobile device 110 and memory wall server 130 may run on one Local Area Network (LAN) and may be incorporated into the same physical or logical system, or different physical or logical systems. Alternatively, the mobile device 110 and memory wall server 130 may reside on different LANs, wide area networks, cellular telephone networks, etc. that may be coupled together via the Internet but separated by firewalls, routers, and/or other network devices. In yet another configuration, the memory wall server 130 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

The memory wall server 130 is responsible for providing digital memory walls to memory wall client 112 of mobile device 110. In one embodiment, a digital memory wall is similar to a digital bulletin board on which users can post, view, sort, etc. digital memories. In one embodiment, the digital memories may include images, video, audio, text messages, links, or other digital user-created multimedia content. In one embodiment, a digital memory wall is associated with a real-world location, as well as a physical surface at the real world location. As will be discussed below, memory wall system 132 provides the digital memories to memory wall client 112 to display or render over an image, or field of view, of the physical surface. By displaying the digital media data over the physical surface, memory wall client augments reality and creates a digital bulletin board at the physical location. For example, digital memories (e.g., pictures, video, audio, notes, etc.) associated with a particular digital memory wall may be displayed over an actual wall at a restaurant, thereby connecting digital memories with a real-world location. In one embodiment, the digital memories may be posted to the digital memory wall by memory wall client 112 of mobile device 110, as well as other memory wall clients (not shown).

In one embodiment, prior to presenting a digital memory wall to memory wall client 112, memory wall system 132 at memory wall server 130 informs memory wall client 112 that a user of mobile device is proximate to, or within a given distance from, one or more digital memory walls. In one embodiment, memory wall client 112 sends location data associated with the real world location of the mobile device 110 to memory wall system 132. In one embodiment, the location data is global positioning system (GPS) data captured by a sensor of mobile device 110. In one embodiment, memory wall client 112 may transmit location data to memory wall system 132 automatically at periodic intervals. In one embodiment, memory wall client 112 may also transmit location data to memory wall system 132 in response to a user-request to determine whether mobile device 110 is proximate to a digital memory wall.

In one embodiment, memory wall system 132 utilizes the received location data of mobile device 110 to query a digital memories database 134. In one embodiment, digital memories database stores digital memories associated with a plurality of digital memory walls. In one embodiment, each digital memory wall stored in digital memories database 134 is associated with a real-world location. Memory wall system 132 uses the received location data to determine whether there are any digital memory walls near the real-world location of the mobile device 110. When memory wall system 132 determines that mobile device 110 is located near a memory wall, memory wall system 132 transmits a notification message to memory wall client 112.

In one embodiment, memory wall client 112 receives the notification and activates one or more user interface elements of the mobile device 110. In one embodiment, memory wall client 112 informs a user of mobile device 110 that a digital memory wall is nearby.

In one embodiment, in order to display a memory wall, memory wall client 112 captures digital images of real-world objects with a digital camera (not shown) of the mobile device. A real-world object may be a person, place, or thing. In one embodiment, the digital images of the real-world objects may include still photographs, digital video, a sequence of digital photographs, a live video feed, etc. In one embodiment, mobile device 110 captures a digital image at the physical location of the digital memory wall. In one embodiment, the digital image captures image data of a physical marking, or identifier, on a physical surface of an object. In one embodiment, the physical marking is associated with a digital memory wall. Memory wall client 112 transmits the digital image, which includes image data for the physical marking, to memory wall server 130. In one embodiment, memory wall client 112 also transmits a current location data (i.e., GPS data) for the mobile device 110 to the memory wall server 130.

In one embodiment, memory wall system 132 at memory wall server 130 receives the digital image data and location data from the memory wall client 112. In one embodiment, memory wall system 132 performs one or more image recognition analysis techniques on the received image data to attempt to locate and interpret the physical marking/identifier within the digital image data. In one embodiment, the physical marking is an identifier associated with one or more digital memory walls. In one embodiment, the physical marking may be a symbol, glyph, identification number, word, etc. on a physical surface. In one embodiment, a particular arrangement of physical objects, such as a set of empty picture frames, white squares painted on a wall, or other arrangement of real-world objects may be recognized as a digital memory wall marking/identifier.

In one embodiment, when memory wall system 132 recognizes the physical marking, memory wall system 132 queries the digital memories database based on the recognized physical marking and the location data provided by memory wall client 112. In one embodiment, memory wall system 132 utilizes both the location data and physical marking identifier to search for digital memories because digital memory walls are specific to particular physical locations, and particular physical locations may include more than one distinct digital memory walls. In one embodiment, a digital memory wall could be automatically revealed to a memory wall client 112 exploring the world with an augmented reality application. In this embodiment, any physical object, boundaries of a physical wall, item, marking, etc. that is associated with a digital memory wall could reveal itself to the memory wall client 112 when it is within the field of view of the augmented reality application.

In one embodiment, memory wall system 132 provides one or more located digital memories to memory wall client 112. In one embodiment, memory wall system 132 may provide additional media data to memory wall client 112 with the digital memories. For example, memory wall system 132 may provide advertisements or other relevant media content to supplement the located digital memories. In one embodiment, the media data provided by a digital memory wall is curated by the user or entity that created, or is otherwise associated with, the digital memory wall. Thus, the curator, or owner, of a digital memory wall would have authority over the content associated with a digital memory wall, as if the digital memory wall were a physical space. In one embodiment, the authority may include specification of particular media items to be displayed at a digital memory wall, priority between media associated with the digital memory wall, priority between different users that have posted to the digital memory wall, type and frequency of advertisements displayed at a digital memory wall, etc.

In one embodiment, memory wall client 112 displays the received digital memories over an image of the physical surface as a digital bulletin board. In one embodiment, where mobile device 110 is a user-wearable computing device (e.g., FIGS. 7 and 8), memory wall client 112 renders the received digital memories over a field of view of a user corresponding to the physical surface of the digital memory wall.

In one embodiment, memory wall client 112 may then transmit received user requests to memory wall system 132 for additional digital memories associated with the digital memory wall. Memory wall system 132 queries digital memories database 134 for additional digital memories. In embodiment, memory wall system 132 transmits additional digital memories to memory wall client 112 for display on the digital memory wall.

In one embodiment, memory wall client 112 may also post new digital memories to a digital memory wall. In one embodiment, digital media data, such as digital images, video, audio, text messages, links, etc. may be transmitted by memory wall client 112 to memory wall system 132. In one embodiment, the digital media data may be media data captured by mobile device 110 at the physical location. In one embodiment, the digital media data may be any user-created or user-supplied media data. In one embodiment, memory wall system 132 receives the digital media data, and stores it in the digital memories database 134 along with an association to the particular digital memory wall. In one embodiment, when memory wall client 112 captures and uploads an image to memory wall sever 130, memory wall server 130 utilizes the location data indicative of where the digital image was captured, and automatically adds the digital image to a memory wall proximate to the location data. The proximate digital memory wall may be the closest memory wall to where the digital image was captured, a digital memory wall selected based on user preferences, based on contents of the image, etc.

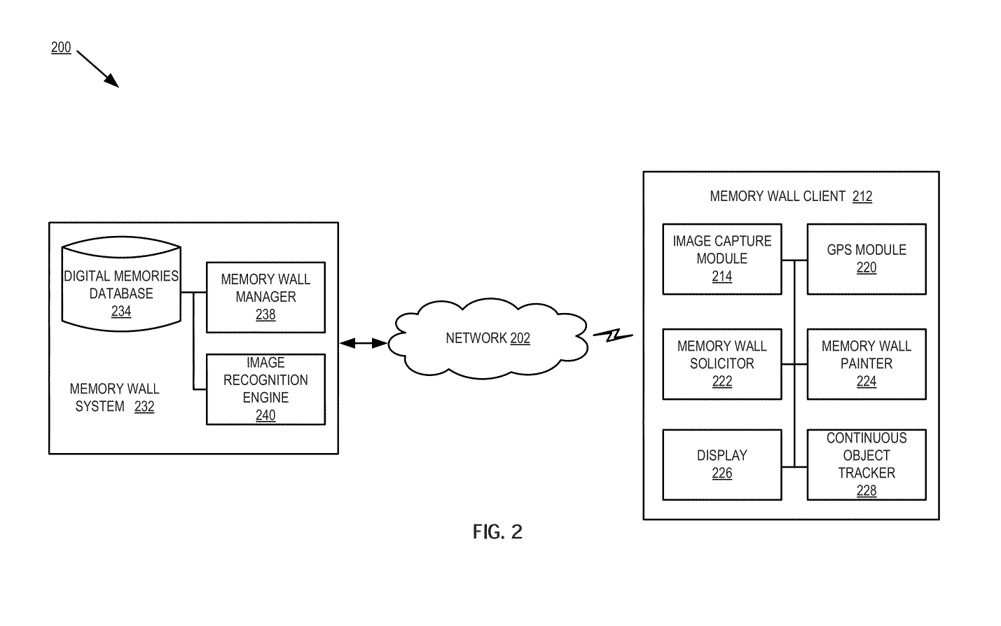

FIG. 2 is a block diagram of one embodiment 200 of a memory wall system and a memory wall client. Memory wall client 212 and memory wall system 232 provide additional details for the memory wall client 112 and memory wall system 132 discussed above in FIG. 1.

In one embodiment, memory wall client 212 may include an image capture module 214, a memory wall solicitor 222, a memory painter 224, a continuous object tracker 228, a display 226, and a global positioning system (GPS) module 220. In one embodiment, memory wall system 232 may include an image recognition engine 240, a memory wall manager 238, and a digital memories database 234. In one embodiment, the memory wall client 212 and memory wall system 232 communicate with each other over various networks and network configurations as discussed above in FIG. 1.

In the memory wall client 212, memory wall solicitor 220 transmits location data captured by global positioning system (GPS) module 220 to memory wall manager 238. In one embodiment, memory wall solicitor 222 causes GPS module to 220 to capture the location data periodically or in response to a user request. Memory wall manager 238 utilizes the location data to query digital memories database 234 to determine whether there are any digital memory walls proximate to the location data. Memory wall manager 238 transmits results of the query to memory wall solicitor 222. In one embodiment, when memory wall client 212 is proximate to a digital memory wall, memory wall solicitor 222 activates one or more user interface elements of a mobile device. In one embodiment, memory wall solicitor 222 displays a message on display 226, causes a mobile device to vibrate, causes mobile device to sound an alarm, etc.

In one embodiment, memory wall solicitor 222 periodically, and transparently to a user, transmits location data to memory wall system. In this embodiment, memory wall solicitor 222 only alerts a user when memory wall client 212 is determined to be located near a digital memory wall.

In one embodiment, image capture module 214 of memory wall client is responsible for capturing digital images of real world objects, including physical markings for digital memory walls. The digital images may include still digital photographs, a series of still digital photographs, a recorded video, a live video feed, etc. In one embodiment, image capture module 214 is a digital camera of a mobile device. In one embodiment, memory wall solicitor 222 transmits the captured digital image(s) or video, along with location data, to memory wall system 232.

In one embodiment, image recognition engine 240 receives the location and digital image data, and performs one or more image recognition analysis techniques on the image data in an attempt to locate and recognize a physical marking denoting a digital memory wall within the digital image data. Image recognition engine 240 analyzes the digital image to generate one or more digital signatures for real-world objects within the digital image. In one embodiment, image recognition engine 240 calculates a feature vector from pixels of the digital image, where values in the feature vector correspond to relevant pixels within the image. This feature vector then becomes a digital signature for a real-object within the digital image. Image recognition engine 240 utilizes the digital signature to search a digital image index (not shown). When image recognition engine 240 finds a match between the digital signature generated for the digital image, and a digital signature for a digital memory wall identifier (e.g., the physical marking, image, glyph, identification number, etc.) image recognition engine 240 informs memory wall manager 238.

In one embodiment, memory wall manager 238 utilizes the matched digital memory wall identifier and the previously received location data to query digital memories database 234. In one embodiment, the digital memories database 234 may store digital memories, such as images, videos, multimedia data, links, text messages, etc. created by users and posted to the identified memory wall at the particular location. In one embodiment, memory wall manager 238 determines one or more digital memories to transmit to memory wall client 212. In one embodiment, memory wall manager 238 may filter digital memories associated with the identified digital memory wall based on one or more factors, such as time, relevance, available bandwidth, etc., and transmits the digital memories to memory wall solicitor 222.

In one embodiment, memory wall solicitor 222 receives the digital memories and provides them to memory wall painter 224. In one embodiment, memory wall painter 224 renders the digital memories over image data of the digital memory wall. In one embodiment, memory wall painter 224 renders the image data in a standard format, such as a grid, list, etc. over the physical surface associated with the digital memory wall. In another embodiment, memory wall painter 224 may render the digital memories over the physical surface associated with the digital memory wall according to formatting instructions received from the memory wall system 232 with the digital memories. In yet another embodiment, memory wall painter 224 may render the digital memories over the physical surface associated with the digital memory wall according to the physical arrangement of the space.

In one embodiment, continuous object tracker 228 aids memory wall painter 224 when memory wall painter 224 renders digital memories over video data. In one embodiment, continuous object tracker 228 determines a set of coordinates, a bounding box, or some other location, of the digital memory wall within the digital image data. Continuous object tracker 228 then provides this location data to memory wall painter 224, so that memory wall painter 224 can render the digital memories over the digital image at the appropriate location within the moving video data within the display 226.

In one embodiment, memory wall solicitor 222 may receive user commands for additional digital memories associated with a digital memory wall. In one embodiment, memory wall solicitor 222 requests the additional digital memories from memory wall system. Memory wall manager 232 queries digital memories database 234, and responds with the additional digital memories. Memory wall client 212 displays the additional digital memories to a user as discussed above.

In one embodiment, image capture module 214 or other user input device (not shown) may capture one or more media data, such as images, video, audio, user-inputted text, etc. In one embodiment, memory wall solicitor 222 transfers the captured media data to memory wall system 232 for posting to a digital memory wall. In one embodiment, memory wall manager 238 receives the digital media data and stores the digital media data in digital memories database 234. In one embodiment, memory wall manager 238 may store the received media data as digital memories for a previously identified digital memory wall. In one embodiment, memory wall manager 238 may store the received media data as digital memories for a memory wall based on the memory wall client's 212 proximity to a digital memory wall.

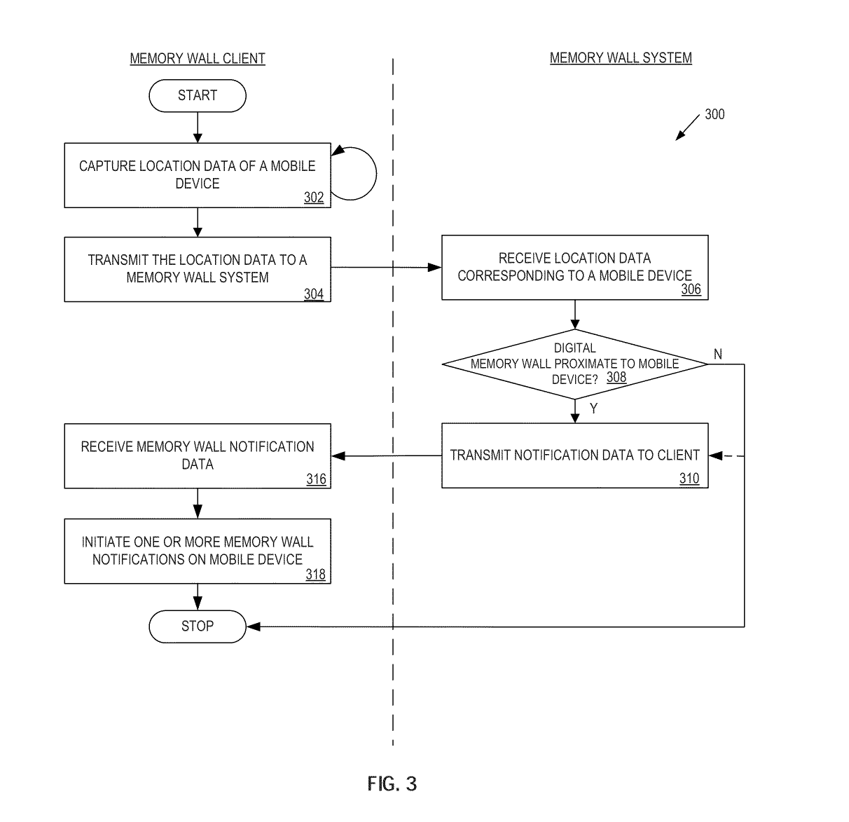

FIG. 3 is a flow diagram of one embodiment of a method 300 for enabling digital memory wall proximity notifications. The method 300 is performed by processing logic that may comprise hardware (circuitry, dedicated logic, etc.), software (such as is run on a general purpose computer system or a dedicated machine), firmware, or a combination. In one embodiment, the method 300 is performed by a memory wall client and a memory wall system (e.g., memory wall client 112 or 212, and memory wall system 132 or 232).

Referring to FIG. 3, processing logic begins by capturing location data of a mobile device (processing block 302). In one embodiment, the location data will be utilized by a memory wall system to determine whether the mobile device is located near one or more digital memory walls. In one embodiment, the location data of the mobile device may be captured periodically, in response to a user-generated memory wall proximity request, or automatically and without intervention of a user. Processing logic transmits the location data to a memory wall system (processing block 304).

Processing logic receives the location data (processing block 306) and determines if there is a digital memory wall proximate to the mobile device (processing block 308). In one embodiment, a mobile device may be determined to be proximate to a digital memory wall when the mobile device is within an average range of human visibility to the memory wall, within a preset distance (e.g., within 10 feet, within 100 feet, etc.), etc. When there are no memory walls near a mobile client, the process ends. In one embodiment, as indicated by the dashed line, where a memory wall client has requested to know whether a digital memory wall is nearby, instead of ending, processing logic may transmit a notification indicating that the memory wall client is not near a digital memory wall, consistent with the discussion of processing blocks 310-318 below.

When processing logic determines that the mobile device is near one or more digital memory walls (processing block 308), processing logic transmits a notification to the client (processing block 310). In one embodiment, the notification indicates that memory wall client is located proximate to at least one digital memory wall. In one embodiment, the notification may also indicate the number of digital memory walls the memory wall client is proximate to, the distance to each digital memory wall, a location of each digital memory wall, a description of the proximate digital memory walls, etc.

Processing logic receives the memory wall notification data (processing block 316) and initiates one or more memory wall notification on a mobile device (processing block 318). In one embodiment, the notification may cause a mobile device to vibrate, active a ring or chime, cause a visual notification to be displayed via a user interface of a mobile device (e.g., a popup message, text message, application alert, image augmentation, etc.), etc.

In one embodiment, notification that a user is near a digital memory wall enables the user to attempt to locate and/or capture digital image data of the physical surface associated with the digital memory wall. Where a user is using a wearable computing device, the notification may inform the user to pan their field of view until they are looking at the physical surface associated with the digital memory wall. In one embodiment, the notification may further augment the field of view of the user to illustrate the location of the digital memory wall, or illustrate the digital memory wall itself.

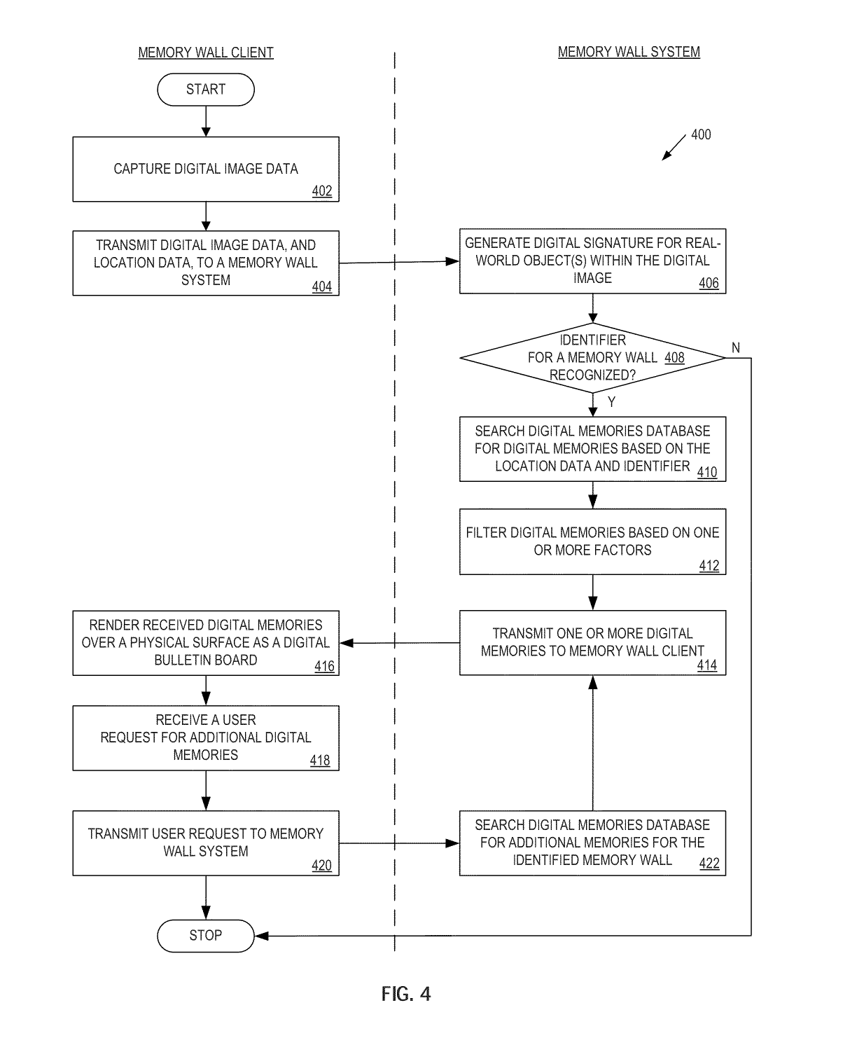

FIG. 4 is a flow diagram of one embodiment of a method 400 for supplying digital memories for a digital memory wall. The method 400 is performed by processing logic that may comprise hardware (circuitry, dedicated logic, etc.), software (such as is run on a general purpose computer system or a dedicated machine), firmware, or a combination. In one embodiment, the method 400 is performed by a memory wall client and a memory wall system (e.g., memory wall client 112 or 212, and memory wall system 132 or 232).

Referring to FIG. 4, processing logic begins by capturing digital image data and location data (processing block 402). In one embodiment, the image data and location data are captured by a mobile device. In one embodiment, the digital image data includes real world objects, such as people, places, things, etc. Processing logic transmits the digital image data, and location data, to a memory wall system (processing block 404).

Processing logic at the memory wall system generates a signature for real-world object(s) within the digital image data (processing block 406). In one embodiment, the digital signature is a feature vector extracted from the digital image of the real-world object and provides a unique identification of the real-world object. Processing logic determines if an identifier for a memory wall is recognized within the digital image data (processing block 408). In one embodiment, the identifier is a physical marking, such as a specific image, word, glyph, PIN, etc. on the surface of an object within the image data.

When no memory wall identifiers are recognized, the process ends. However, when one or more memory wall identifiers are recognized, processing logic searches a digital memories database for digital memories based on the location data and the identifier (processing block 410). As discussed above, digital memories may include user-posted photos, videos, audio, links, etc. associated with the digital memory wall. The digital memories may be relevant to a physical location where the digital memory wall is located.

Processing logic filters located digital memories based on one or more factors (processing block 412). In one embodiment, processing logic may locate a large number of digital memories. Thus, processing logic filters the number of digital memories based on various factors, such as when the digital memory was posted to a digital memory wall, the type of media data in the digital memory, available bandwidth for transferring the digital memories, etc. Processing logic then transmits one or more digital memories to the memory wall client (processing block 414). In one embodiment, processing logic may also transmit one or more advertisements along with the digital memories.

Processing logic at the memory wall client renders received digital memories over digital image data of a physical surface (processing block 416). In one embodiment, the digital memories are rendered based on instructions by the memory wall client, based on a determined configuration of the surface, based on one or more preferences of the memory wall client, etc. In one embodiment, the digital memories are rendered as a digital bulletin board of user images, video, audio, notes, advertisements, etc. In one embodiment, where the processing logic is being executed in a wearable computing device, the solicitation for and display of digital memories associated with a digital memory wall may occur automatically, and without intervention of a user. In the embodiment, processing logic automatically augments the reality of a user by rendering digital memory all data over a field of view of a user, such digital memory wall notifications, display of digital memories, etc.

In one embodiment, processing logic then receives a user request for additional memories (processing block 418). In one embodiment, the request may include one or more factors to be applied to filter available digital memories. Processing logic transmits the request to memory wall system (processing block 420), and processing logic at the memory wall system searches digital memories database for additional memories associated with the identified digital memory wall (processing block 422).

In one embodiment, the process ends when memory wall client, such as may be run on a mobile computing device, user wearable computing device, etc., closes. In another embodiment, the process ends when memory wall client ceases to capture digital image data of, or ceases to direct the camera at, the physical surface of a digital memory wall.

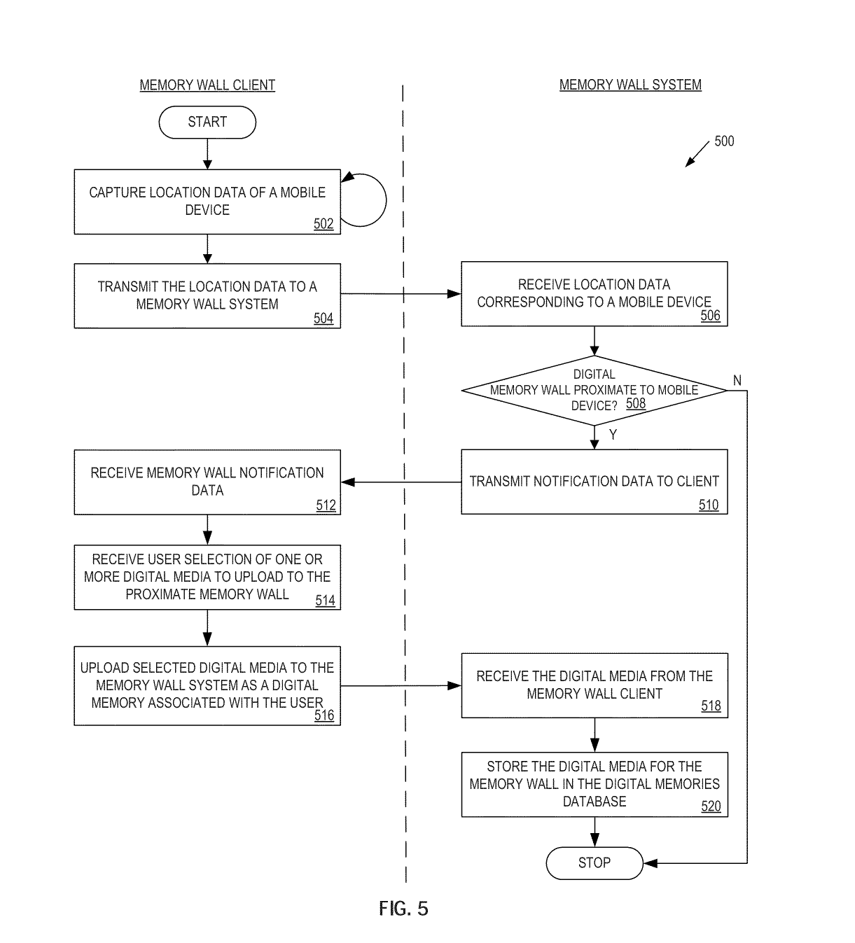

FIG. 5 is a flow diagram of one embodiment of a method 500 for enabling the addition of content to an existing digital memory wall. The method 500 is performed by processing logic that may comprise hardware (circuitry, dedicated logic, etc.), software (such as is run on a general purpose computer system or a dedicated machine), firmware, or a combination. In one embodiment, the method 500 is performed by a memory wall client and a memory wall system (e.g., memory wall client 112 or 212, and memory wall system 132 or 232).

Referring to FIG. 5, processing logic begins by capturing location data of a mobile device (processing block 502). In one embodiment, as discussed above, the location data is GPS data. Processing logic then transmits the location data to a memory wall system (processing block 504).

Processing logic receives the location data from the mobile device (processing block 506) and determines whether the mobile device is proximate to a digital memory wall (processing block 508). When processing logic determines that a mobile device is not located proximate to a digital memory wall, the process ends. However, when the mobile device is proximate to a digital memory wall, processing logic transmits notification data to the memory wall client (processing block 510).

Processing logic at the memory wall client receives the notification data (processing block 512). Processing logic then receives user selection of one or more digital media to upload to the proximate memory wall (processing block 514), and upload the selected digital media data (processing block 516). In one embodiment, the uploaded digital media data is to be a digital memory associated with the proximate digital memory wall.

Processing logic at the memory wall system receives the digital media from the memory wall client (processing block 518), and stores the digital media for the digital memory wall in the digital memories database (processing block 520).

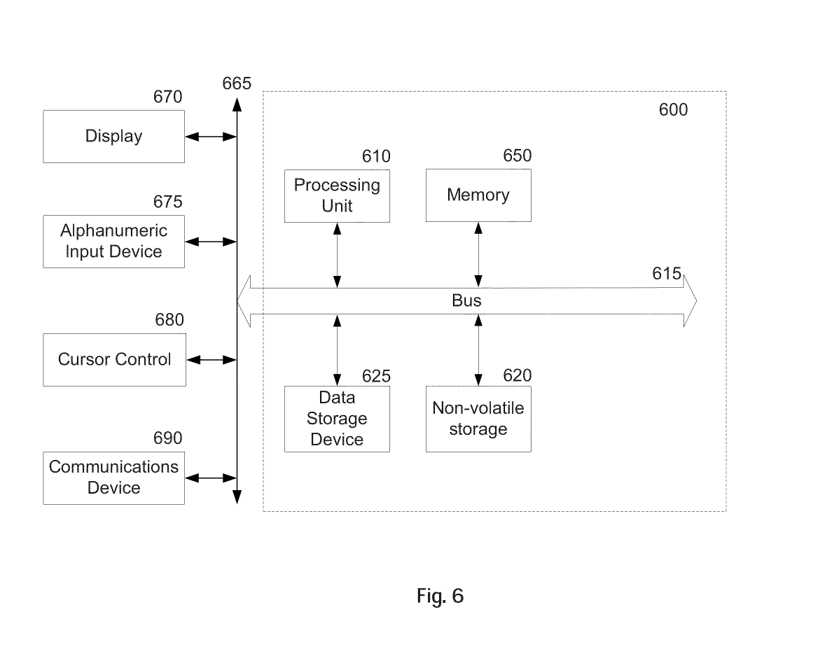

FIG. 6 is one embodiment of a computer system that may be used with the present invention. It will be apparent to those of ordinary skill in the art, however that other alternative systems of various system architectures may also be used.

The data processing system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a cathode ray tube (CRT) or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the computer system 600 and the outside world. Note that any or all of the components of this system illustrated in FIG. 6 and associated hardware may be used in various embodiments of the present invention.

It will be appreciated by those of ordinary skill in the art that any configuration of the system may be used for various purposes according to the particular implementation. The control logic or software implementing the present invention can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The present invention may also be embodied in a handheld or portable device containing a subset of the computer hardware components described above. For example, the handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function.

FIG. 7 illustrates an example system 700 for receiving, transmitting, and displaying digital memories. The system 700 is shown in the form of a wearable computing device. While FIG. 7 illustrates eyeglasses 702 as an example of a wearable computing device, other types of wearable computing devices could additionally or alternatively be used. As illustrated in FIG. 7, the eyeglasses 702 comprise frame elements including lens-frames 704 and 706 and a center frame support 708, lens elements 710 and 712, and extending side-arms 714 and 716. The center frame support 708 and the extending side-arms 714 and 716 are configured to secure the eyeglasses 702 to a user's face via a user's nose and ears, respectively. Each of the frame elements 704, 706, and 708 and the extending side-arms 714 and 716 may be formed of a solid structure of plastic or metal, or may be formed of a hollow structure of similar material so as to allow wiring and component interconnects to be internally routed through the eyeglasses 702. Each of the lens elements 710 and 712 may be formed of any material that can suitably display a projected image or graphic. Each of the lens elements 710 and 712 may also be sufficiently transparent to allow a user to see through the lens element. Combining these two features of the lens elements can facilitate an augmented reality or heads-up display where the projected image or graphic is superimposed over a real-world view as perceived by the user through the lens elements.

The extending side-arms 714 and 716 are each projections that extend away from the frame elements 704 and 706, respectively, and are positioned behind a user's ears to secure the eyeglasses 702 to the user. The extending side-arms 714 and 716 may further secure the eyeglasses 702 to the user by extending around a rear portion of the user's head. Additionally or alternatively, for example, the system 100 may connect to or be affixed within a head-mounted helmet structure. Other possibilities exist as well.

The system 700 may also include an on-board computing system 718, a video camera 720, a sensor 722, and finger-operable touch pads 724, 726. The on-board computing system 718 is shown to be positioned on the extending side-arm 714 of the eyeglasses 702; however, the on-board computing system 718 may be provided on other parts of the eyeglasses 702. The on-board computing system 718 may include a processor and memory, for example. The on-board computing system 718 may be configured to receive and analyze data from the video camera 720 and the finger-operable touch pads 724, 726 (and possibly from other sensory devices, user interfaces, or both) and generate images for output from the lens elements 710 and 712. The video camera 720 is shown to be positioned on the extending side-arm 714 of the eyeglasses 702; however, the video camera 720 may be provided on other parts of the eyeglasses 702. The video camera 720 may be configured to capture images at various resolutions or at different frame rates. Many video cameras with a small form-factor, such as those used in cell phones or webcams, for example, may be incorporated into an example of the system 700. Although FIG. 7 illustrates one video camera 720, more video cameras may be used, and each may be configured to capture the same view, or to capture different views. For example, the video camera 720 may be forward facing to capture at least a portion of the real-world view perceived by the user. This forward facing image captured by the video camera 720 may then be used to generate an augmented reality where computer generated images appear to interact with the real-world view perceived by the user.

The sensor 722 is shown mounted on the extending side-arm 716 of the eyeglasses 702; however, the sensor 722 may be provided on other parts of the eyeglasses 702. The sensor 722 may include one or more of a gyroscope or an accelerometer, for example. Other sensing devices may be included within the sensor 722 or other sensing functions may be performed by the sensor 722. The finger-operable touch pads 724, 726 are shown mounted on the extending side-arms 714, 716 of the eyeglasses 702. Each of finger-operable touch pads 724, 726 may be used by a user to input commands. The finger-operable touch pads 724, 726 may sense at least one of a position and a movement of a finger via capacitive sensing, resistance sensing, or a surface acoustic wave process, among other possibilities. The finger-operable touch pads 724, 726 may be capable of sensing finger movement in a direction parallel or planar to the pad surface, in a direction normal to the pad surface, or both, and may also be capable of sensing a level of pressure applied. The finger-operable touch pads 724, 726 may be formed of one or more translucent or transparent insulating layers and one or more translucent or transparent conducting layers. Edges of the finger-operable touch pads 724, 726 may be formed to have a raised, indented, or roughened surface, so as to provide tactile feedback to a user when the user's finger reaches the edge of the finger-operable touch pads 724, 726. Each of the finger-operable touch pads 724, 726 may be operated independently, and may provide a different function.

FIG. 8 illustrates an alternate view 800 of the system 700 of FIG. 7. As shown in FIG. 8, the lens elements 810 and 812 may act as display elements. The eyeglasses 802 may include a first projector 828 coupled to an inside surface of the extending side-arm 816 and configured to project a display 830 onto an inside surface of the lens element 812.

Additionally or alternatively, a second projector 832 may be coupled to an inside surface of the extending sidearm 814 and configured to project a display 834 onto an inside surface of the lens element 810. The lens elements 810 and 812 may act as a combiner in a light projection system and may include a coating that reflects the light projected onto them from the projectors 828 and 832.

In some embodiments, a special coating may not be used (e.g., when the projectors 828 and 832 are scanning laser devices). In alternative embodiments, other types of display elements may also be used. For example, the lens elements 810, 812 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 804 and 806 for driving such a matrix display. Alternatively or additionally, a laser or LED source and scanning system could be used to draw a raster display directly onto the retina of one or more of the user's eyes. Other possibilities exist as well.

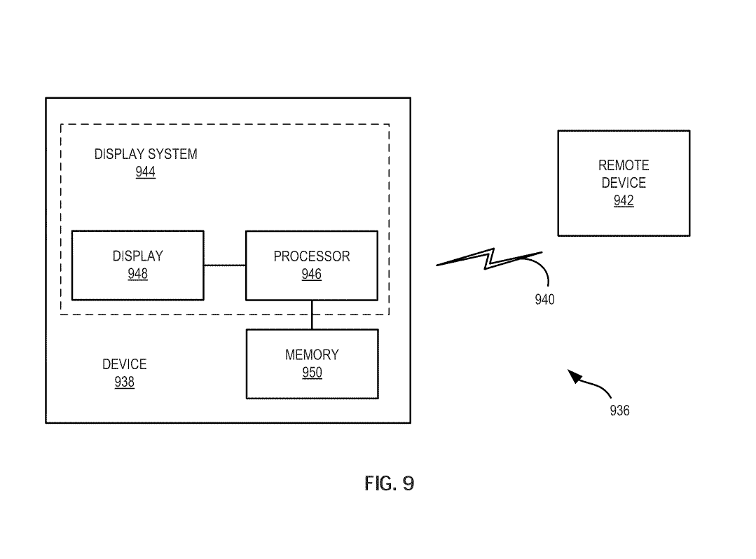

FIG. 9 illustrates an example schematic drawing of a computer network infrastructure. In one system 936, a device 938 communicates using a communication link 940 (e.g., a wired or wireless connection) to a remote device 942. The device 938 may be any type of device that can receive data and display information corresponding to or associated with the data. For example, the device 938 may be a heads-up display system, such as the eyeglasses 702 and 802 described with reference to FIGS. 7 and 8. Thus, the device 938 may include a display system 944 comprising a processor 946 and a display 948. The display 948 may be, for example, an optical see-through display, an optical see-around display, or a video see-through display. The processor 946 may receive data from the remote device 942, and configure the data for display on the display 948. The processor 946 may be any type of processor, such as a micro-processor or a digital signal processor, for example. The device 938 may further include on-board data storage, such as memory 950 coupled to the processor 946. The memory 950 may store software that can be accessed and executed by the processor 946, for example.

The remote device 942 may be any type of computing device or transmitter including a laptop computer, a mobile telephone, etc., that is configured to transmit data to the device 938. The remote device 942 and the device 938 may contain hardware to enable the communication link 940, such as processors, transmitters, receivers, antennas, etc.

In FIG. 9, the communication link 940 is illustrated as a wireless connection; however, wired connections may also be used. For example, the communication link 940 may be a wired link via a serial bus such as a universal serial bus or a parallel bus. A wired connection may be a proprietary connection as well. The communication link 940 may also be a wireless connection using, e.g., Bluetooth® radio technology, communication protocols described in IEEE 802.11 (including any IEEE 802.11 revisions), Cellular technology (such as GSM, CDMA, UMTS, EVDO, WiMAX, or LTE), or Zigbee® technology, among other possibilities. The remote device 942 may be accessible via the Internet and may comprise a computing cluster associated with a particular web service (e.g., social-networking, photo sharing, address book, etc.).

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A computer-implemented method, comprising:
receiving, at a server computer system, digital image data and location data captured by a mobile device;
performing image recognition analysis on objects within the digital image data to recognize a physical marking on a surface of an object depicted in the digital image data;
determining that a recognized physical marking is associated with a digital memory wall based on the recognized physical marking and the location data; and
providing digital media associated with the digital memory wall to the mobile device to augment the surface of the object depicted in the digital image data with the digital media, wherein the digital media comprises a plurality of multimedia data generated by a plurality of different users, and at least one multimedia data is posted by at least one user as a digital memory to the digital memory wall corresponding to the location data and the physical marking, prior to receipt of the digital image data, and wherein the digital memory wall acts as a digital bulletin board to augment a display of the surface of the object depicted in the digital image data with the plurality of multimedia data.

2. The computer-implemented method of claim 1, further comprising:
receiving an initial location data captured by a mobile device, wherein the initial location data is not associated with digital image data;
querying a database to determine whether the mobile device is proximate to one or more digital memory walls based on the received initial location data; and
providing a notification to the mobile device when the mobile device is proximate to one or more digital memory walls based on results of the querying.

3. The computer-implemented method of claim 1, further comprising:
receiving digital media data from the mobile to be associated with the digital memory wall as a digital memory; and
adding the received digital media data to a database of digital memories associated with the digital memory wall.

4. The computer-implemented method of claim 1, wherein providing digital media associated with the digital memory wall to the mobile device further comprises:
locating a plurality of digital media objects associated with the digital memory wall;
filtering the located plurality of digital media objects based on one or more factors; and
providing a filtered set of digital media objects to the mobile device to be rendered over the physical surface of the object.

5. The computer implemented method of claim 1, wherein the digital media associated with the digital memory wall includes at least one advertisement.

6. (canceled)

7. The computer-implemented method of claim 1, wherein the physical marking on the surface of the object is one of a glyph, an image, a pin on the surface of the object, or a visual indicator on one or more edges of a wall.

8. The computer-implemented method of claim 1, wherein the mobile device is a user-wearable computing device.

9. The computer-implemented method of claim 1, wherein the mobile device is a mobile telephone.

10. A non-transitory computer readable storage medium including instructions that, when executed by a processor, cause the processor to perform a method comprising:
receiving digital image data and location data captured by a mobile device;
performing image recognition analysis on objects within the digital image data to recognize a physical marking on a surface of an object depicted in the digital image data;
determining that a recognized physical marking is associated with a digital memory wall based on the recognized physical marking and the location data; and
providing digital media associated with the digital memory wall to the mobile device to augment the surface of the object depicted in the digital image data with the digital media, wherein the digital media comprises a plurality of multimedia data generated by a plurality of different users, and at least one multimedia data is posted by at least one user as a digital memory to the digital memory wall corresponding to the location data and the physical marking, prior to receipt of the digital image data, and wherein the digital memory wall acts as a digital bulletin board to augment a display of the surface of the object depicted in the digital image data with the plurality of multimedia data.

11. The non-transitory computer readable storage medium of claim 10, further comprising:
receiving an initial location data captured by a mobile device, wherein the initial location data is not associated with digital image data;
querying a database to determine whether the mobile device is proximate to one or more digital memory walls based on the received initial location data; and
providing a notification to the mobile device when the mobile device is proximate to one or more digital memory walls based on results of the querying.

12. The non-transitory computer readable storage medium of claim 10, further comprising:
receiving digital media data from the mobile to be associated with the digital memory wall as a digital memory; and
adding the received digital media data to a database of digital memories associated with the digital memory wall.

13. The non-transitory computer readable storage medium of claim 10, wherein providing digital media associated with the digital memory wall to the mobile device further comprises:
locating a plurality of digital media objects associated with the digital memory wall;
filtering the located plurality of digital media objects based on one or more factors; and
providing a filtered set of digital media objects to the mobile device to be rendered over the physical surface of the object.

14. The non-transitory computer readable storage medium of claim 10, wherein the digital media associated with the digital memory wall includes at least one advertisement.

15. (canceled)

16. The non-transitory computer readable storage medium of claim 10, wherein the physical marking on the surface of the object is one of a glyph, an image, a pin on the surface of the object, or a visual indicator on one or more edges of a wall.

17. The non-transitory computer readable storage medium of claim 10, wherein the mobile device is a user-wearable computing device.

18. The non-transitory computer readable storage medium of claim 10, wherein the mobile device is a mobile telephone.

19. A system comprising:
a memory; and
a processor coupled with the memory to
receive digital image data and location data captured by a mobile device,
perform image recognition analysis on objects within the digital image data to recognize a physical marking on a surface of an object depicted in the digital image data,
determine that a recognized physical marking is associated with a digital memory wall based on the recognized physical marking and the location data, and
provide digital media associated with the digital memory wall to the mobile device to augment the surface of the object depicted in the digital image data with the digital media, wherein the digital media comprises a plurality of multimedia data generated by a plurality of different users, and at least one multimedia data is posted by at least one user as a digital memory to the digital memory wall corresponding to the location data and the physical marking, prior to receipt of the digital image data, and wherein the digital memory wall acts as a digital bulletin board to augment a display of the surface of the object depicted in the digital image data with the plurality of multimedia data

20. The system of claim 19, wherein the processor is further to receive digital media data from the mobile to be associated with the digital memory wall as a digital memory, and add the received digital media data to a database of digital memories associated with the digital memory wall.
